(19) United States
(12) Patent Application Publication
(10) Pub. No.: US 2017/0253339 A1
(43) Pub. Date: Sep. 7, 2017

(54) GLIDE MODULATOR SYSTEM AND METHOD FOR A RAM AIR PARACHUTE

(71) Applicant: AIRBORNE SYSTEMS NA INC., Pennsauken, NJ (US)

(72) Inventor: Jean C. BERLAND, Wynnewood, PA (US)

(73) Assignee: AIRBORNE SYSTEMS NA INC., Pennsauken, NJ (US)

(21) Appl. No.: 15/061,804

(22) Filed: Mar. 4, 2016

(51) Int. Cl. B64D 17/34; B64D 17/24; B64D 17/18; B64D 17/02

(52) U.S. Cl. CPC B64D 17/34; B64D 17/025; B64D 17/24; B64D 17/18

(57) ABSTRACT

A system and method is provided for shortening specific suspension lines near the center of a ram air parachute in order to distort the airfoil section only in the center section of the canopy. This distortion of the center section results in a significant alteration of the glide ratio of the parachute by simultaneously reducing the forward speed and increasing the rate of descent. Meanwhile, because the canopy is only distorted in the center section, the wingtips remain extended and pressurized so that the steering apparatus at the trailing edge of the canopy remains fully functional to direct the heading.

### BACKGROUND OF THE INVENTION

Field of the Invention

The present invention is related to the field of parachutes and, more particularly, to ram air/parafoil parachutes for personnel or cargo.

Description of the Related Art

Until recently, ram air parachutes had a glide ratio of less than 4:1. With the development of more efficient airfoil sections, higher aspect ratio (span/chord) canopies, and more refined wing planforms, the glide ratio has increased to up to 6:1 for parachutes and even up to 10:1 for ground launched paragliders. The increase in glide ratio allows greater flight distances from the same deployment altitude.

While increased glide ratios are often advantageous in the generally recreational field of paragliding where the pilot is flying a gliding aircraft and may want to remain aloft for a long period, there are conditions under which it is necessary for a paraglider to decrease the glide ratio and thus increase the rate of descent, such as to escape dangerous strong ascending currents. To this end, techniques have been developed in the field of paragliding to increase the rate of descent. Two of these techniques are known in the art as the “B-line stall” and the “big ears”. Both of these techniques alter the glide ratio by reducing the lift and increasing the drag of the canopy.

The B-line stall technique consists of pulling down the risers connected to the entire second row of suspension lines (the B row). The effect is a major distortion of the airfoil section across the entire span of the paraglider canopy resulting in a loss of lift and, therefore, a significant increase in the rate of descent. As the distortion affects the entire span, the steering lines located at the trailing edge near the wing tips become ineffective and the pilot must thereafter control the heading of the paraglider by shifting his or her weight in the direction of the desired turn.

FIG. 1 is a chordwise cross-sectional view of a paraglider. It depicts the paraglider 1 being flown by a pilot 2, flying along the nominal glide path 3 in a high glide ratio configuration. FIG. 1 also shows the location of the different suspension line rows along the chord: front row 4 (“A”) nearest the leading edge of the canopy or wing, median rows 5, 6 (“B”, “C” and “D” respectively), rear row 7 (“E”) and steering lines 8 on or adjacent the trailing edge. The risers 9, 10 and 11 that group the suspension lines are also shown.

FIG. 2 shows the distortion of the airfoil section that results from the pilot pulling on the B riser 10 connected to the B lines 5 to produce the B-line stall configuration. The disruption of the airflow along the top and bottom surfaces of the canopy reduces the lift and the paraglider flies at a much steeper glide slope 12. In the B-line stall configuration, the steering lines are ineffective at controlling the direction or heading of the paraglider.

A conventional paraglider wing in nominal flight is shown in FIG. 3. As an alternative means of distorting the wing to reduce the glide slope, a “big ears” technique may be used. A “big ears” configuration, which is shown in FIGS. 4 and 5, is produced by pulling down the front row suspension lines at the wing tips 13 in order to fold the wing tips under the bottom surface of the wing, thereby reducing the span of the wing and hence the canopy surface area. The “big ears” technique significantly decreases the wing area and aspect ratio while increasing parasitic drag, causing the glide path to become much steeper. However, due to the folding of the wing tips, the steering lines become totally inoperative and the pilot must shift his or her weight in the harness to control the heading.

The control obtained through weight shifting, which is required after implementing either the B-line stall or the “big ears” technique, is very limited and therefore only possible in practice with paragliders which are very lightweight. Even with paragliders, however, executing the B-line stall is a radical and delicate maneuver. Because the wing has lost a lot internal pressurization, it could exhibit violent behavior.

When turning to the use of parachutes deployed from high altitude with a jumper and/or a payload, the B-line stall and the “big ears” techniques are impractical and not effective, particularly in connection with parachutes that are designed for military operations carrying heavily loaded jumpers. When secured in a military parachute harness attached to a large heavy rucksack, the jumper has little ability to shift his or her weight in order to change direction. As a result, the maneuverability is limited.

Further, in a military operation, a ram air parachute with a high glide ratio that cannot be rapidly altered can compromise the mission. For example, if the jumper is part of an operational military mission and arrives over the target with significant excess altitude, the jumper is forced to loiter in the air for an extended period of time, repeatedly circling over the target. This protracted time above the landing zone can result in the jumper becoming a target for the enemy. The ability to lose altitude rapidly on demand, while maintaining effective control of the heading, becomes increasingly important in the field of high performance ram air parachutes for personnel and cargo as deployed by the military.

Therefore, a need exists for a system and method for modulating the glide path of a personnel or cargo-laden ram air parachute so that the rate of descent may be rapidly increased and forward speed reduced, while the effectiveness of the steering lines to control parachute heading is retained.

### SUMMARY OF THE INVENTION

In view of the foregoing, the present invention is directed to a personnel or cargo ram air gliding parachute equipped with a device or system that can be activated during flight to shorten only centrally positioned suspension lines located on the B line row, generally close to the center of pressure of the airfoil, in order to distort the center section of the canopy while the wingtips remain extended and pressurized so that the steering system remains fully functional to control the heading.

According to a preferred embodiment, the system includes a modulating line connected only to the centermost B line on each side of the canopy. The jumper, or an automated system, pulls down on the modulating lines when the glide ratio must be reduced, with the resulting distortion of just the center section of the parachute canopy reducing the forward speed and increasing the rate of descent while retaining the functionality of the trailing edge steering control system.

Accordingly, it is an object of the present invention to provide a device for use with a personnel or cargo ram air parachute that is activated during flight to shorten judiciously selected lines located on the B line row (generally close to the center of pressure of the airfoil) in the center of the canopy in order to distort only the center section, resulting in an increased rate of descent and reduced forward speed, while the canopy retains internal pressurization.

Another object of the present invention is to provide a device for use with a personnel or cargo ram air parachute in accordance with the preceding object that allows for gradual or immediate shortening of the selected lines in the B row (generally close to the center of pressure of the airfoil for dynamically controlled modulation of the glide path.

A further object of the present invention is to provide a device for use with a personnel or cargo ram air parachute in accordance with the preceding objects that allows for glide path modulation while maintaining full steering capability.

Yet another object of the present invention is to equip a personnel or cargo ram air parachute with a system that provides for significant modification of the glide angle through the use of control lines and toggles without interfering with the operational efficiency of the trailing edge steering system.

Still another object of the present invention is to provide a method of retrofitting a personnel or cargo ram air gliding parachute with a device configured to shorten lines located on the B line row (generally close to the center of pressure of the airfoil) in the center of the canopy in order to distort only the canopy center section to modify the glide slope of the parachute during flight.

Yet still another object of the present invention is to provide a method of retrofitting a personnel or cargo ram air gliding parachute in accordance with the preceding object in which the method includes providing a legacy ram air gliding parachute with an additional pair of modulating lines attached only to the center B lines (generally close to the center of pressure of the airfoil), said lines being usable to modulate the glide path while the efficiency of the trailing edge steering system is fully maintained.

Still another object of the present invention is to provide a device for use with a personnel or cargo ram air gliding parachute in accordance with the preceding objects that includes a modulating component operative to distort only the center area of the canopy to reduce the glide ratio from the highest glide ratio to the lowest glide ratio and to effect this reduction either gradually or quickly.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a cross-sectional chordwise view of a conventional paraglider having a plurality of suspension lines located along five rows A-E, as well as steering lines and risers used to group the suspension lines.

FIG. 2 shows the paraglider of FIG. 1 after the airfoil section has been distorted by pulling on the B riser connected to the B lines across the entire span of the canopy to effect a B-line stall.

FIG. 3 is a top view of a conventional paraglider canopy or wing during nominal flight.

FIG. 4 is a top view of the wing shown in FIG. 3 when in a “big ears” configuration is initiated with the wing tips pulled down as is known in the sport of paragliding.

FIG. 5 is a front view of the “big ears” configuration shown in FIG. 4.

FIG. 6 is a bottom view of a one-half side of a ram air parachute having a modulating line connected to the centrally located B lines in accordance with the present invention.

FIG. 7 shows a chordwise view of a ram air parachute at line 50 of FIG. 6, in the direction indicated by A-A, having a modulating line and only two risers per side, and shown before the modulating line is pulled down, in accordance with the present invention.

FIG. 7A is an enlarged view of Detail A shown in FIG. 7.

FIG. 8 shows the chordwise view of the ram air parachute shown in FIG. 7 with the modulating line pulled down and the center section of the canopy distorted, in accordance with the present invention.

FIG. 8A is an enlarged view of Detail A shown in FIG. 8.

FIG. 9 is an enlarged view of the modulating line engaged in the cleat shown in FIGS. 8 and 8A which is used to lock the modulating line in a pulled down configuration to set the parachute in the rapid descent (low glide ratio) configuration according to the present invention.

FIG. 10 is a front perspective view of a parachute with the center B lines pulled down to distort the center part of the canopy in accordance with the present invention.

FIG. 11 is a front cross-sectional view taken along the B suspension line of the parachute shown in FIG. 10.

FIG. 12 is chordwise view of a ram air parachute with the suspension lines cascaded chordwise rather than spanwise.

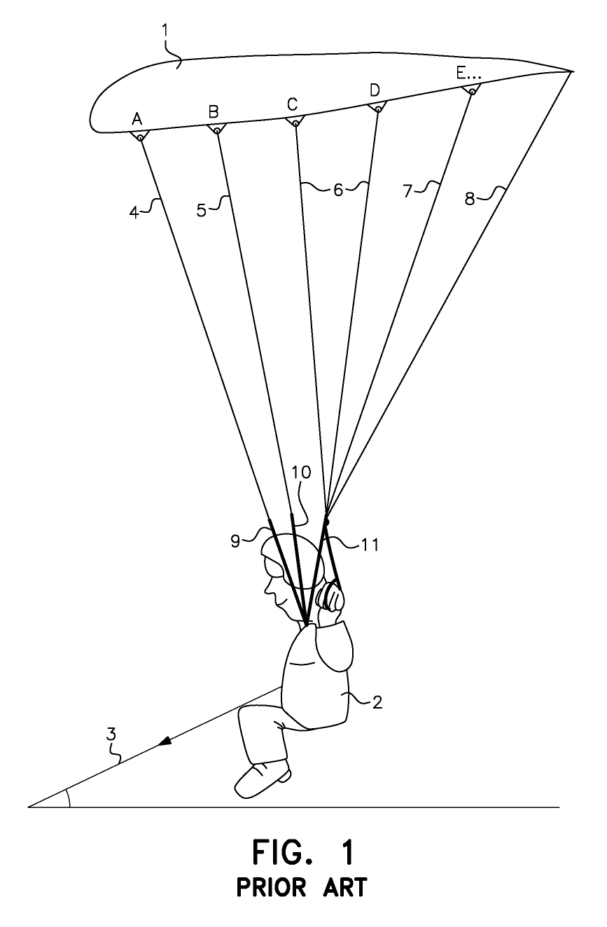

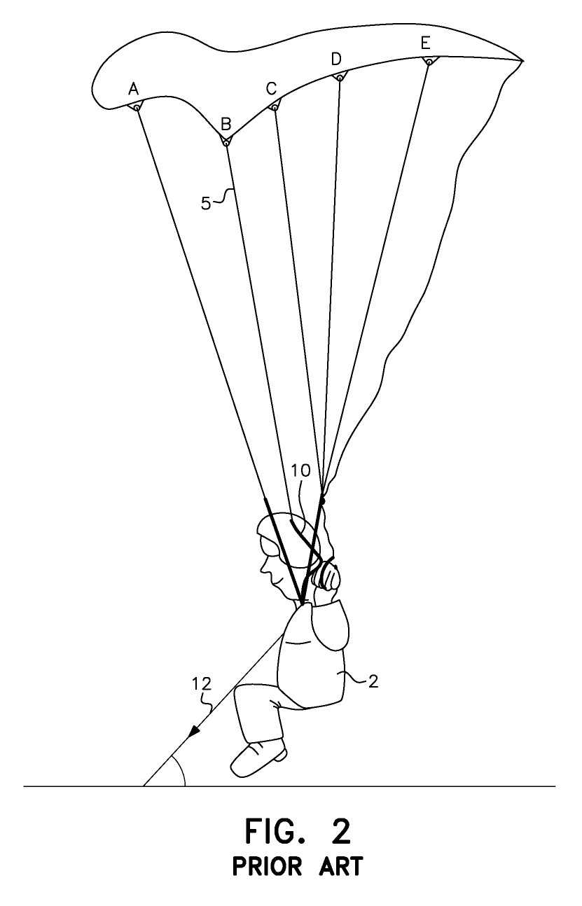

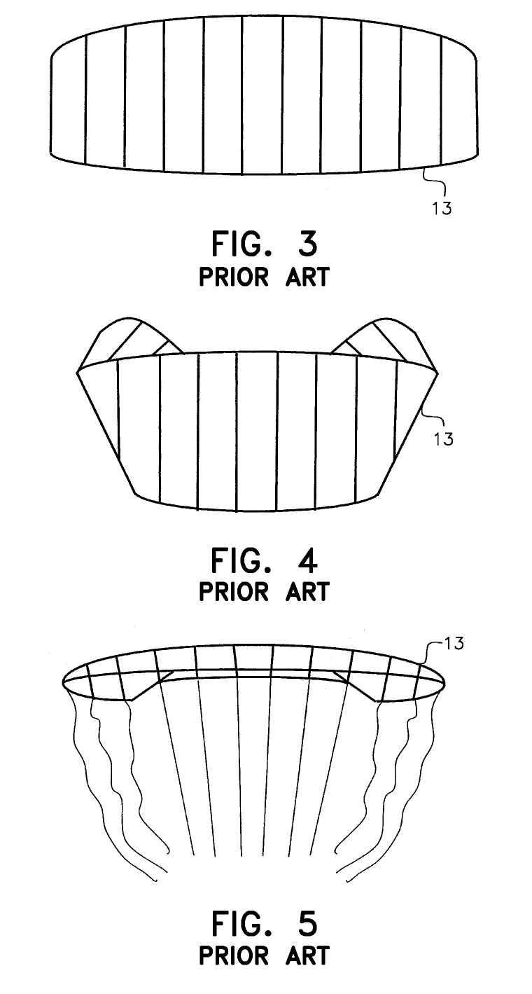

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

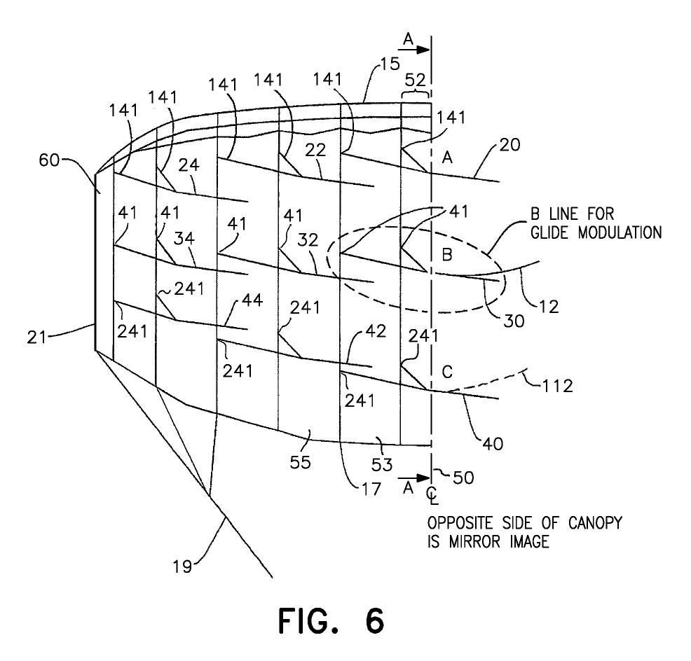

As shown in FIG. 6, which is a view of a one-half side of the bottom surface of a ram air parachute, the present invention is directed to a ram air parachute having a plurality of suspension lines ordered in lines that extend span-wise across the canopy 60 and generally parallel with one another from adjacent the leading edge 15 to the trailing edge 17. For ease of illustration of the suspension lines, FIG. 6 shows only the A lines, the B lines, the C lines and the trailing edge steering lines 19 on a one-half side of the parachute canopy 60. The opposite side of the parachute (not shown) is a mirror image of the side shown in FIG. 6. As known to those skilled in the art, there may be suspension lines in addition to the A, B and C lines, such as D lines, E lines, etc. on larger sized canopies.

This invention is directed to personnel and cargo ram air parachutes for which the lower parts of some suspension lines are cascaded spanwise into a plurality of upper suspension lines that are attached to the bottom surface of the canopy as shown in FIG. 6. While the lower part of the suspension line generally cascades into two or more upper suspension lines as shown, the suspension line can also be continuous and directly attach to the bottom surface of the canopy. In the case of large cargo ram air parachutes, such as those having a carrying capacity of greater than 2000 lb, the suspension lines typically cascade and it might be necessary to pull on more than one B line on each side of the canopy center cell in order to achieve the desired glide modulation. In general, efficient glide modulation is achieved when the center portion comprising approximately 30% of the span is distorted.

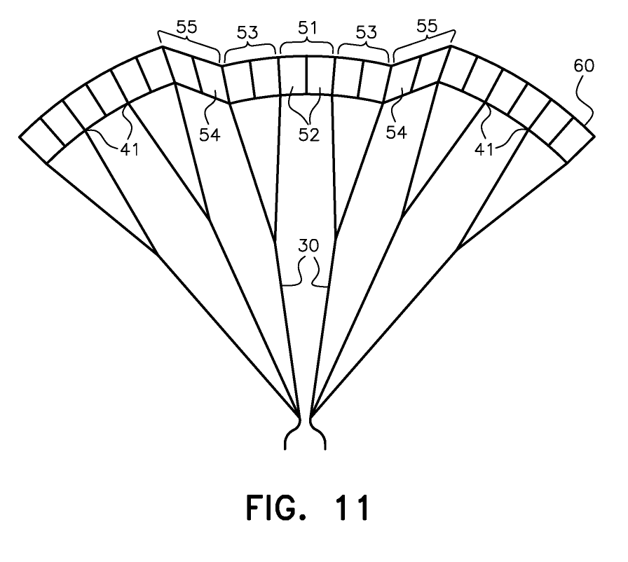

With respect to the terms “B line” and “B suspension line” as used herein, these terms are intended to refer to the entire length of the suspension line from the canopy to the riser with the understanding that the “B line” or “B suspension line” is a single line at its lower end portion which joins the riser and may be either a single line at its opposite upper end portion that is attached to the canopy or, more commonly in the case of large ram air parachutes, several upper end lines that cascade from the single lower end portion of the line to attach to the canopy at multiple attachment points 41 (see also FIGS. 10 and 11). In FIG. 6, the centermost B line 30 cascades into two attachment points 41, each of the A lines cascades into two attachment points 141, and so on with respect to the C lines. Hence, reference to the B suspension line as a “line” is intended to include both a direct single “line” attachment and the multiple attachment point configuration that results from multiple lines cascading near the top of the “B line” or “B suspension line” that is only one line upon reaching the riser.

As shown, the A lines extend laterally across the span of the canopy between the wing tips and are connected to the canopy 60 nearest the leading edge 15. The A lines include an inner line 20, an outer line 24 and a middle line 22 spaced from and between the inner line 20 and the outer line 24, each of the A lines 20, 22 and 24 having two attachment points 141. Similarly, the B lines include an inner line 30, an outer line 34 and a middle line 32 spaced from and between the inner line 30 and the outer line 34, with each of the B lines 30, 32 and 34 having two attachment points 41, and the C lines include an inner line 40, an outer line 44 and a middle line 42 spaced from and between the inner line 40 and the outer line 44, each of the C lines also having two attachment points 241. Again, there may be more than three lines in each of the A, B and C rows in large span canopies.

As shown in FIG. 6, the B lines are spaced rearwardly from the A lines, and the C lines are spaced rearwardly from the B lines. The inner B lines 30 are shown cascading for attachment on either side of the center cell 51 (see FIG. 11) of the canopy; only a half cell 52 of the center cell 51 is shown in FIG. 6. The half cell 52, the adjoining cell 53 and a half cell 54 of the next adjoining cell 55 (see FIG. 11) are distorted when the modulating line 12 is pulled down as illustrated in FIG. 6. A steering line 19 is attached at or near the trailing edge 17 of the canopy 60 adjacent the wing tip 21. The inner B line 30 on each side of the center cell is the only B line used for glide modulation of the parachute in accordance with the present invention, enabling the system to be readily implemented. As the opposite side (not illustrated) of the one-half canopy shown in FIG. 6 is a mirror image, it is evident that there are two modulating lines, one on each of the centermost B lines 30 on either side of the center cell 51 of the parachute. However, if the B lines are not cascaded, i.e., if the lower end of the single B suspension line on each side of the canopy that is pulled down to modulate the glide slope does not cascade into several upper lines that are attached to the underside of the canopy but is attached at a single point as a “direct” line, the direct line on each side of the canopy center cell along the B row may be used.

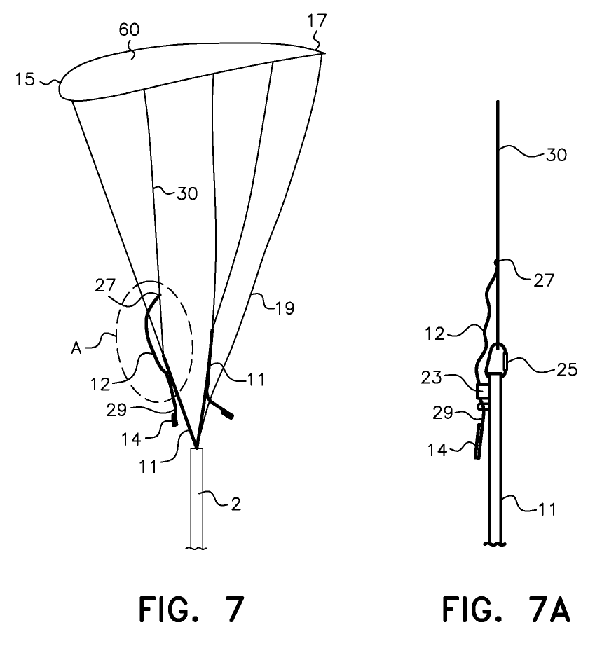

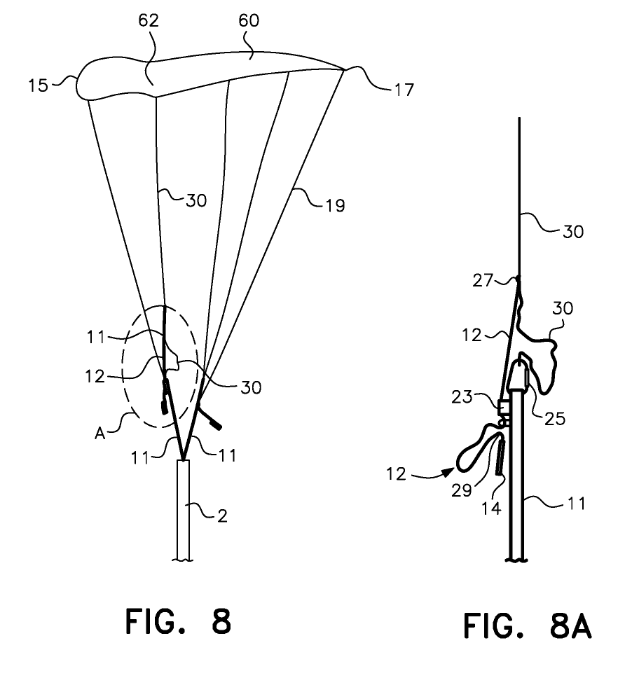

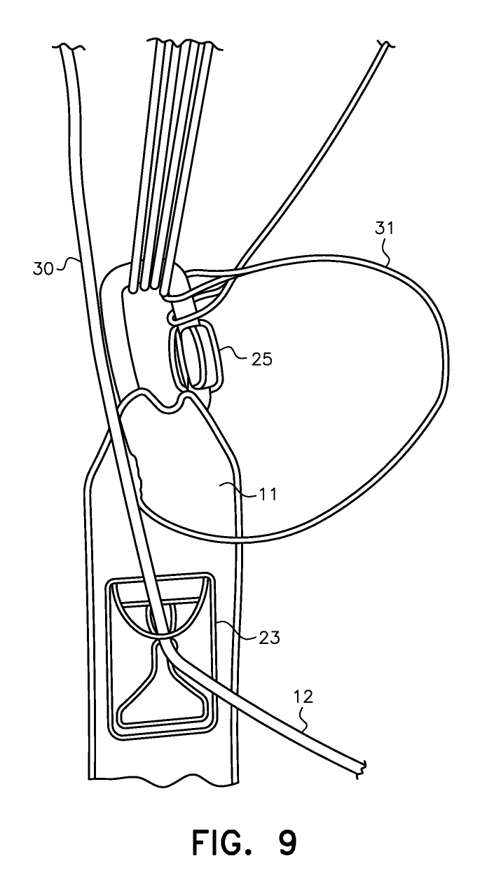

In a preferred embodiment shown in FIGS. 7 and 8, the parachute suspension lines are connected, such as through a rapid link 25 (well known in the art), to only two risers 11 on each side. For clarity, FIGS. 7 and 8 show only one side of the parachute as taken at line 50 in the direction indicated A-A. As already stated in connection with FIG. 6, the side opposite the side illustrated in FIG. 6 is a mirror image. The direction A-A toward the mirror image side is indicated in order to correspond with the leading and trailing edge orientation, i.e., leading edge to the left and trailing edge to the right, shown in FIGS. 7 and 8.

According to the present invention, a modulating component, embodied as an additional line and referred to herein as the modulating line 12, is provided in conjunction with the inner B line on each side of the canopy center cell. One end 27 of the modulating line 12 is connected by stitching or the like to the B line 30 and the other end 29 of the modulating line 12 is equipped with a toggle 14. In a preferred configuration, the length of the modulating line is between about 5% and about 10% of the total length of the B line as measured from the link to the canopy. The toggle on the end 29 can be grasped by the jumper to exert a downward pull on the modulating line. The full canopy view of FIG. 10 and the cross sectional view of FIG. 11 show the resulting distortion in the center of the canopy when the left and right B lines on either side of the center cell 51 are pulled down. According to a preferred embodiment, the B suspension lines are shortened by between about 5% and about 10% of their length when modulated. The terms “left” and “right” when used herein to refer to the B lines are intended to provide clarity with respect to the position of the B lines as being on each side of the center cell.

As would be understood, the terms “left” and “right” are relative and not absolute, as the “left” side of the canopy when viewed from the leading edge would, of course, be the “right” side when the same canopy is viewed from the trailing edge.

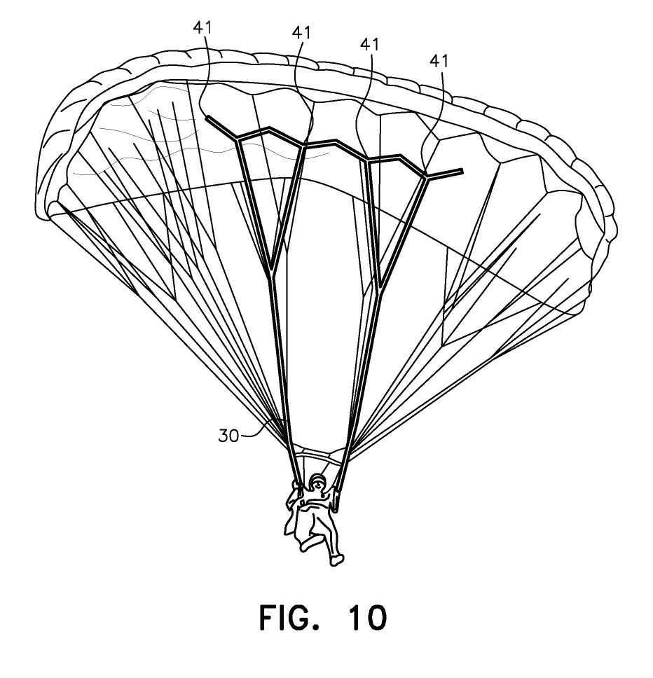

As shown in the chordwise canopy view of FIG. 7 and enlarged Detail A shown in 7A, when the modulating line is not being used and the parachute is flying with the canopy fully open, there is slack in the modulating line 12 while the B line 30 is taut. To reduce the glide slope ratio, the toggle 14 attached to the end 29 of the modulating line 12 is pulled downwardly which, in turn, tightens the modulating line so that the attached end 27 pulls down on the B line. The downward pull on the B line distorts a center section 62 of the canopy 60 while creating slack in the B line as shown in FIGS. 8, 8A and 9. The distortion of the center section 62 of the canopy 60 serves to modulate the glide ratio of the parachute by reducing forward speed and increasing the rate of descent while the steering lines 19 on both sides at the trailing edge 17 remain fully operational to control heading. In most cases, distortion of about 30% of the span provides good glide modulation.

After the modulating line 12 is pulled down to set the parachute in the rapid descent (low glide ratio) configuration, the modulating line 12 can be locked in a securing element, such as a small cleat 23 located on the front of the riser 11 as shown in FIGS. 7A, 8A and 9. FIG. 9 shows the B line 30 after being pulled down by the modulating line 12, with the modulating line having been secured in the cleat 23. As shown by the loop 31 in FIG. 9, there is slack in the B line 30 when the modulating line 12 has been pulled down to modulate the glide slope. Alternatively, the jumper has the option to keep the toggle 14 of the line 12 in hand and manually modulate the glide slope as necessary. Other mechanisms beside the toggle 14 and cleat 23 can be used to set or fix the modulating line 12 in the pulled-down configuration to maintain the distortion in the center of the canopy through tension on the inner B lines.

In addition to use of the modulating line after deployment as has been described, the ram air parachute may be configured such that the modulating line is pulled down and secured during the parachute packing phase in order to deploy the parachute in a low glide ratio mode. When so configured, the glide modulation line is released after deployment to allow the parachute to fly at its maximum glide ratio capability. Once the glide modulation line is released, such line may thereafter be again pulled down to modulate the glide ratio during flight in the same manner as a parachute configured to be deployed without initial distortion of the center of the canopy.

As has been described herein, the present invention is directed to a system, device and method that consists of pulling only the left and right B lines in the center section 62 of the canopy 60 where the chord is the longest as shown in the perspective view of FIG. 10 and the cross-sectional front view of FIG. 11 taken along the B suspension line. The centrally located B lines, one on each of the left and right sides of the canopy, are used because the B line attachment points to the canopy are generally located closest to the center of pressure of the airfoil.

FIG. 11 shows both the cells and division of the cells into so-called half cells across the span of the canopy 60. When the modulating lines (not shown in FIGS. 10 and 11) attached to the centermost B suspension lines 30 are pulled down, the resulting distortion of the center cell 51, the adjoining cells 53 and the half cells 54 of the next adjoining cells 55 reduces the lift and increases the drag in the center of the canopy. Based on the current state of development and testing of the present invention, good glide modulation of the parachute is achieved when about 30% of the span is distorted in the center section 62. However, the entire canopy retains its internal pressurization so that the left and right outboard cells are unaffected by this maneuver and the steering lines 19 at the canopy trailing edge 17 remain fully functional, allowing full steering control in a conventional manner and eliminating any need for the jumper to rely on weight shifting in the harness in an effort to steer the parachute.

In the tested configuration of a parachute equipped with the glide modulation system according to the present invention, the glide ratio was easily reduced from 5.5:1 to approximately 1:1 by the system and method of the present invention. The glide modulation can be achieved gradually or directly from the maximum to the lowest glide ratio.

While the invention has been described herein with reference to attaching the modulating lines to only the B-lines nearest the center of the canopy, in the case of larger canopies it may be advantageous to pull on more of the B-lines, while staying in the center portion of the canopy. For example, in the case of a ram air parachute having 11 cells, the B-lines on four line attachment points 41 (two on each side) may be pulled by the modulating lines as shown in FIG. 10. With a ram air parachute having 31 cells, six line attachment points on each side of the canopy center may need to be pulled in order to distort a sufficiently large part of the center portion of the canopy.

The present invention is also applicable to precision guided aerial delivery. The Airborne Guidance Unit (AGU) is equipped with an actuator connected to the B lines to modulate the glide while the original left and right actuators are utilized to steer the parachute left and right. It is also conceivable that the parachute could be steered with a single actuator and that the glide modulation could be effected with a dedicated actuator.

Once the glide modulation system is disengaged by the parachutist or by the AGU, the parachute will return to its original glide slope configuration.

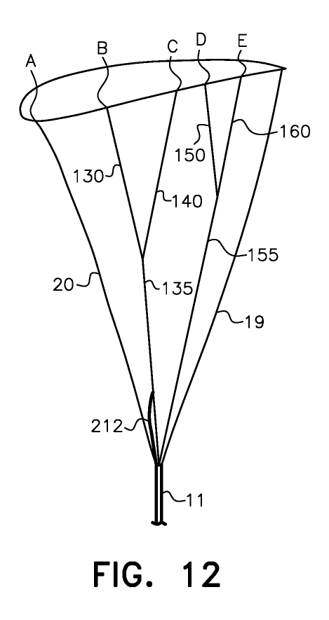

In line with the foregoing description, it may be possible to modulate the glide slope by shortening only the centermost C suspension lines, rather than the centermost B lines in accordance with the present invention. A modulating line 112 attached to the centermost C row suspension line 40 is shown by the dotted line 112 in FIG. 6. It is also possible to shorten both the centermost B lines and the centermost C lines by cascading the suspension lines chordwise. As shown in FIG. 12, the innermost B suspension line 130 and the innermost C suspension line 140 cascade from the lower line 135 which joins the riser 11. Similarly, the D suspension line 150 and the E suspension line 160 cascade from the lower line 155. The modulating line 212 is attached to the line 135 and may be used to pull down on both the innermost B and C suspension lines at the same time. Whether the innermost B line only, the innermost C line only or the chordwise cascading B and C lines together are used depends upon the particular canopy's center of pressure. However, the preferred embodiment is to shorten one centrally located B line on each side of the canopy, as the B line attachment point to the canopy is generally located closer to the center of pressure of the airfoil.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A glide path modulation system for a personnel ram air gliding parachute or a cargo ram air gliding parachute comprising:
a ram air gliding parachute having a canopy, a plurality of B lines extending across a span of said canopy, and a plurality of C lines extending across said span of said canopy and located rearwardly of said plurality of B lines with respect to a leading edge of the parachute, said B lines including a first pair of B lines nearest a center section of said canopy along said span, one of said first pair of B lines being attached to the canopy on either side of a center cell, and at least a second pair of B lines spaced outwardly from said first pair of B lines on either side of the canopy, said C lines including a first pair of C lines nearest a center section of said canopy along said span, one of said first pair of C lines being attached to the canopy on either side of the center cell, and at least a second pair of C lines spaced outwardly from said first pair of C lines;
a steering apparatus located at the trailing edge of said canopy, said trailing edge steering apparatus being used to steer the parachute; and
a device activated during flight to shorten said first pair of B lines only in the center section of the canopy and/or said first pair of C lines only in the center section of the canopy in order to distort only the center section of said canopy, said distortion of said canopy center section increasing the parachute's rate of descent and reducing the parachute's forward speed.

2. The glide path modulation system as set forth in claim 1, wherein only said first pair of B lines in the center section of canopy is pulled down.

3. The glide path modulation system as set forth in claim 2, wherein said trailing edge steering apparatus remains operative to steer said parachute when said canopy center section is distorted.

4. The glide path modulation system as set forth in claim 2, wherein said B lines include a third pair of B lines spaced outwardly from said second pair, said third pair of B lines being nearest a wing tip section of said canopy relative to said first and second pairs of B lines.

5. The glide path modulation system as set forth in claim 2, wherein, for each side of the canopy, said device includes a modulating line attached at one end to one of the first pair of B lines and having an opposite end that when pulled down pulls on the attached B line, the modulating lines on each side of the canopy distorting the center section of the canopy where the first pair of B lines is attached when the modulating lines are pulled down.

6. The glide path modulation system as set forth in claim 5, wherein the opposite end of the modulating line is provided with a toggle.

7. The glide path modulation system as set forth in claim 5, wherein the B line is attached at a lower end thereof to a riser, said riser having a cleat mounted thereon to which the end of the modulating line opposite the attached end is secured when the modulating line has been pulled down to distort the canopy.

8. A method of retrofitting a ram air parachute having a trailing edge steering apparatus and a plurality of suspension lines joined by a link to a riser on each side of the parachute, with a device including modulating lines that are configured to shorten each of a pair of B row suspension lines including a left B line and a right B line on either side of a center cell only in a center section of the canopy in order to distort only said canopy center section, comprising:
attaching, on each side of the center cell of said parachute, one end of a modulating line to one of said pair of B row suspension lines above the riser, an opposite end of said modulating line being releasably coupled to a securing element on said riser to prevent the modulating line from unrestrained movement when not in use;
said opposite end of said modulating line being configured to be decoupled from said securing element during flight and used to pull down on said one of said pair of B row suspension lines to distort only said canopy center section, said distortion increasing the parachute's rate of descent and reducing the parachute's forward speed.

9. The method as set forth in claim 8, wherein attachment of the modulating lines on the B row suspension lines in the center section of the canopy allows the trailing edge steering apparatus to remain operative to control parachute heading.

10. The method as set forth in claim 8, further comprising the step of securing the opposite end of the modulating line to the securing element with tension on the modulating line to retain the distorted aspect of the center section of the canopy in flight.

11. The method as set forth in claim 10, further comprising the step of securing the opposite end of the modulating line to the securing element in a pulled-down configuration when the parachute is packed so that the parachute deploys in a low glide ratio mode.

12. The method as set forth in claim 8, further comprising the step of attaching one end of a modulating line to each of a pair of C row suspension lines only in a center section of the canopy.

13. A method of modulating the glide slope of a personnel ram-air gliding parachute or a cargo ram-air gliding parachute comprising:
providing a ram air gliding parachute having a canopy and a plurality of B lines extending across a span of said canopy, said B lines including a first pair of lines nearest a center cell of said canopy along said span and attached thereto, said first pair of lines including a left B line and a right B line on either side of the center cell, and at least a second pair of lines spaced outwardly from said first pair, said parachute having a trailing edge steering apparatus located adjacent the wing tip sections of said canopy for steering the parachute, said parachute being provided with a glide slope modulating device; and
activating the glide slope modulating device during flight to shorten said first pair of B lines only in the center section of the canopy, in order to distort only the center section of said canopy, said distortion of said canopy center section increasing the parachute's rate of descent and reducing the parachute's forward speed while, at the same time, said trailing edge steering apparatus remains operative to steer said parachute.

14. The method as set forth in claim 13, further comprising continuing to steer the parachute with the trailing edge steering apparatus which remains fully operative when the canopy center section is distorted.

15. The method as set forth in claim 13, wherein said glide slope modulating device includes a left modulating line attached at a first end to the left B line and having an opposite second end, and a right modulating line attached at a first end to the right B line and having an opposite second end, said step of activating including pulling down on the second ends of said left and right modulating lines to pull the left and right B lines down through the attached ends of the modulating lines and distort the canopy center section.

16. The method as set forth in claim 15, wherein each of said left and right B lines is coupled to a respective riser equipped with a securing element on each side of the canopy, said method further comprising, on each side of the canopy and after pulling down on the modulating lines, securing the second ends of the left and right modulating lines to the respective securing element on the respective riser on each side while retaining tension on the modulating lines.

17. The method as set forth in claim 16, wherein said securing element is a cleat, said step of securing including locking the modulating line in said cleat.

18. A device for retrofitting a ram air parachute for controlled glide slope modulation, said ram air parachute having a trailing edge steering apparatus and a plurality of suspension lines joined by a riser on each side, comprising:
a modulating component that is operatively coupled to left and right B row suspension lines only in a center section of the canopy and on opposite sides of a center cell, said modulating component being configured to shorten said left and right B row suspension lines in order to distort only said canopy center section, said distortion increasing the parachute's rate of descent and reducing the parachute's forward speed when in flight while said trailing edge steering apparatus remains operative to control parachute heading when said left and right B row suspension lines are shortened and the canopy center section is distorted.

19. The device as set forth in claim 18, wherein the modulating component includes a left modulating line attached to the left B row suspension line and a right modulating line attached to the right B row suspension line on either side of the center cell of said ram air parachute, each of said modulating lines having an end opposite the attached end that is used by a jumper or an automated device in flight to pull down only the left and right B lines on either side of the center cell in the canopy center section to distort only the canopy center section and reduce a glide ratio of said parachute.

20. The device as set forth in claim 19, wherein the modulating component further includes a securing element on each of the risers, the ends of the modulating lines that are pulled down being releasably coupled to said securing elements on said risers to prevent the modulating lines from unrestrained movement when not in use, said securing elements also being configured to secure and fix said ends of the modulating lines in a pulled-down position to retain distortion of the canopy center section in flight.

21. The device as set forth in claim 20, wherein the ends of the modulating lines are secured to the securing elements without tension when the parachute is packed, said modulating component being activated during flight to shorten said left and right B row suspension lines in order to distort only said canopy center section and reduce the glide ratio in flight.

22. The device as set forth in claim 20, wherein the ends of the modulating lines are secured to the securing elements in a pulled-down configuration when the parachute is packed so that the parachute deploys in a low glide ratio mode, said modulating line ends being configured to be removed in flight to allow the parachute to fly at its maximum glide ratio and to be resecured to the securing elements in the pulled-down configuration to return the parachute to the low glide ratio mode as needed.
